(19) United States
(12) Patent Application Publication
(10) Pub. No.: US 2010/0086292 A1
(43) Pub. Date: Apr. 8, 2010

(54) Device and method for automatically controlling continuous auto focus

(75) Inventors: Oh Sung Byun, Gyunggi-do (KR); Ho Kyoum Kim, Gyunggi-do (KR); Gab Yong Kim, Gyunggi-do (KR); Sung Hyun Kim, Gyunggi-do (KR); Hyung Chan Kwak, Gyunggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO- MECHANICS CO., LTD., Suwon (KR)

(21) Appl. No.: 12/318,960

(22) Filed: Jan. 13, 2009

(30) Foreign Application Priority Data
Oct. 8, 2008 (KR) 10-2008-0098712

(51) Int. Cl. G03B 17/00

(52) U.S. Cl. 396/80

(57) ABSTRACT

Disclosed herein is a device and method for automatically controlling continuous auto focus. The device includes a lens unit installed in a camera module, and configured to receive images of an external subject; a lens actuation unit for moving the lens unit along an optical axis so as to focus on a subject; an image sensor for receiving the external images, converting the external images into image signals, and outputting the image signals; a computation unit for detecting focus values and feature parameters; a mode determination unit for automatically performing switching between general mode, specific mode and tracking mode, setting the mode, and automatically setting a fixed or variable window according to the set mode using the detected feature parameters; and a lens control unit for generating a control signal for controlling the lens actuation unit so as to perform continuous auto focus according to the detected focus values.

### CROSS REFERENCE TO RELATED APPLICATION

This application claims the benefit of Korean Patent Application No. 10-2008-0098712, filed on Oct. 8, 2008, entitled “Automatic Controlling Device of a Continuous Auto Focus and Automatic Controlling Method of the Same,” which is hereby incorporated by reference in its entirety into this application.

### BACKGROUND OF THE INVENTION

1. Field of the Invention

The present invention relates generally to a device and method for automatically controlling continuous auto focus, and, more particularly, to a device and method for automatically controlling continuous auto focus that is capable of, in a camera module for capturing moving images, performing automatic switching between a fixed window and a variable window according to the characteristics of a subject, determining whether a focus value variation falls within a predetermined threshold range when an image pickup region varies, and performing continuous auto focusing on the basis of the fixed or variable window.

2. Description of the Related Art

Recently, camera modules equipped with image pickup devices such as Charge Coupled Device (CCD) image sensors or Complementary Metal Oxide Semiconductor (CMOS) image sensors are provided in mobile devices such as mobile phones. Since camera modules have a large number of pixels and functions, they have capacity similar to that of typical high-capacity digital cameras.

Meanwhile, such camera modules for mobile devices have a function of recognizing a specific region of a subject, particularly a face recognition function capable of recognizing the face of a human (subject).

Furthermore, with the development of hardware and the availability of High Definition (HD)/full HD-class support, the demand for the capture of moving images using mobile devices is increasing. The key issue in the capture of moving images is to maintain continuous auto focus on a subject in real time.

When moving images of subjects that are objects of interest, such as faces, are being captured, camera modules currently provided in mobile devices do not perform automatic continuous focusing chiefly on the objects of interest, but capture images on the basis of cameras and perform only long distance focusing.

Accordingly, when a moving image is captured using a mobile device, there is required a device and method for automatically controlling continuous auto focus that is capable of automatically performing real-time continuous auto focusing according to an object of interest regardless of the distance, automatically determining whether an object of interest exists in a captured screen, and performing auto focusing in a general environment.

### SUMMARY OF THE INVENTION

Accordingly, the present invention has been made keeping in mind the above problems occurring in the prior art, and the present invention is intended to provide a device and method for automatically controlling continuous auto focus that is capable of automatically switching between fixed and variable windows according to an object, that is, a subject, and automatically performing continuous auto focusing on moving images.

In order to accomplish the above object, the present invention provides a device for automatically controlling continuous auto focus, including a lens unit installed in a camera module, and configured to receive images of an external subject; a lens actuation unit for moving the lens unit along a direction of an optical axis so as to perform focusing on a subject; an image sensor for receiving the external images through the lens unit, converting the external images into image signals, and outputting the image signals; a computation unit for detecting the focus values and feature parameters of the subject from the image signals; a mode determination unit for automatically performing switching between general mode, specific mode and tracking mode for the subject, setting the mode for the subject, and automatically setting a fixed or variable window for the subject according to the set mode using the feature parameters detected by the computation unit; and a lens control unit for generating a control signal for controlling the lens actuation unit so that continuous auto focus is performed according to the focus values detected by the computation unit.

Preferably, the mode determination unit sets the fixed window in the general mode, and sets the variable window in the specific mode and the tracking mode.

Preferably, the variable window is set for the subject selected by a user in the tracking mode.

Preferably, the variable window is set for the subject for which a feature parameter is detected from each frame of a moving image in the specific mode.

Preferably, the tracking mode is configured to set the variable window for the subject selected by the user.

Preferably, the computation unit performs continuous auto focusing on a basis of the fixed or variable window set by the mode determination unit, the computation unit determining whether a variation, which is a difference between a focus value for a second image pickup region at an optimal lens location for a first image pickup region and an optimal focus value for the first image pickup region, falls within a threshold value range stored in a memory unit.

In order to accomplish the above object, the present invention provides a method of automatically controlling continuous auto focus, including the steps of (A) selecting general mode, specific mode and tracking mode so that a fixed or variable window is automatically set according characteristics of a subject; (B) scanning focus values at first intervals for a first image pickup region by moving a lens unit on a basis of the fixed or variable window; (C) setting a second scan region including a location of the lens unit at an optimal focus value selected from among the focus values scanned at the step (B), and scanning focus values at second intervals on a basis of the fixed or variable window in the second scan region; (D) placing the lens unit at an optimal lens location having an optimal focus value at the step (C); (E) after an image pickup region has been switched from the first image pickup region to a second image pickup region, determining whether a variation, that is, a difference between a focus value for the second image pickup region and the optimal focus value at the second scan step, falls within a threshold range at the optimal lens location; and (F) moving the lens unit on a basis of the variation determined at the step (E).

Preferably, the step (A) includes setting the fixed window in the general mode and the variable window in the specific mode and the tracking mode.

Preferably, the specific mode has highest priority, so that the specific mode is first performed unless the general mode or the tracking mode is set by the user.

Preferably, the tracking mode is set when one subject is selected from among a plurality of subjects within the image pickup region by the user.

Preferably, the step (A) includes determining whether the specific mode has been set, determining whether the tracking mode has been set by the user while the specific mode is performed, detecting a feature parameter of the subject for each frame of a captured moving image if the specific mode is being performed, recognizing the subject from which the feature parameter is detected as a specific object if the feature parameter has been selected from the frame, and setting the variable window for the specific object.

12. The method as set forth in claim 11, wherein, if the feature parameter has not been detected from the frame of the moving image, a mode is automatically switched from the specific mode to the general mode and the fixed window is set.

Preferably, if the tracking mode is set by selection of one subject from among the plurality of subjects by the user in the specific mode, a feature parameter detected from the selected subject is compared with feature parameters stored in a memory unit.

Preferably, if a parameter similar to the feature parameter detected from the selected subject exists in the memory unit, the variable window is set for the selected subject.

Preferably, if a parameter similar to the feature parameter detected from the selected subject does not exist in the memory unit, a mode is automatically switched from the tracking mode to the general mode and the fixed window is set.

Preferably, the step (A) includes, if the general mode has been set by the user, determining whether the tracking mode has been set by the user in the general mode, and setting the fixed window if the general mode is being performed.

Preferably, if the tracking mode is set by selection of one subject from among the plurality of subjects by the user in the general mode, a feature parameter detected from the selected subject is compared with feature parameters stored in a memory unit.

Preferably, if a parameter similar to the feature parameter detected from the selected subject exists in the memory unit, the variable window is set for the selected subject.

Preferably, if a parameter similar to the feature parameter detected from the selected subject does not exist in the memory unit, a mode is automatically switched from the tracking mode to the general mode and the fixed window is set.

Preferably, the second scan region exists between lens locations having focus values within a preset focus range at an optimal one of the focus values scanned at the step (B).

Preferably, each of the second intervals is narrower than each of the first intervals.

Preferably, the step (F) includes, if the variation falls within the threshold range, performing the step (c) on the second image pickup region.

Preferably, the step (F) includes, if the variation deviates from the threshold range, setting a direction in which the lens unit is moved and then determining whether a mode has been switched from the specific mode to the general mode.

Preferably, if a mode has been switched from the specific mode to general mode, the step (A) is performed.

Preferably, if a mode has not been switched from the specific mode to general mode, the step (B) is performed on the second image pickup region.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram showing a device for automatically controlling continuous auto focus according to the present invention;

FIG. 2 is a schematic flowchart showing a method of automatically control continuous auto focus according to the present invention;

FIG. 3 is a flowchart showing the mode selection step of FIG. 2 in detail; and

FIG. 4 is a schematic diagram showing the feature parameters of a face.

### DESCRIPTION OF THE PREFERRED EMBODIMENTS

Reference now should be made to the drawings, in which the same reference numerals are used throughout the different drawings to designate the same or similar components.

A device and method for automatically controlling continuous auto focus according to preferred embodiments of the present invention will be described with reference to the accompanying drawings below.

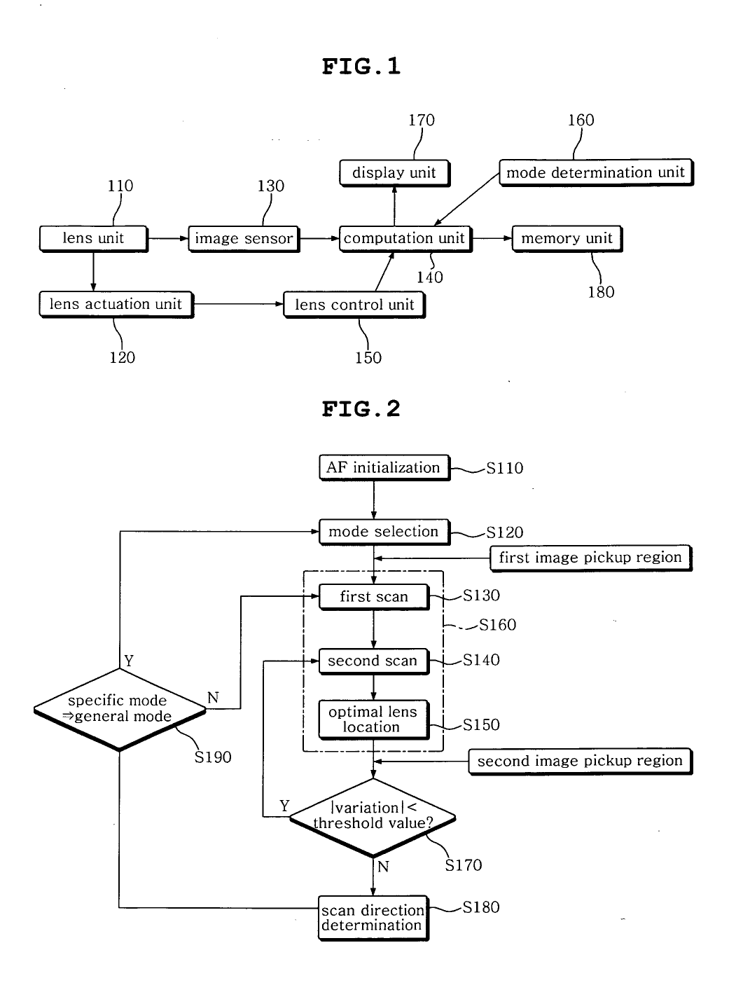

As shown in FIG. 1, a device for automatically controlling continuous auto focus 100 according to a preferred embodiment of the present invention includes a lens unit 110, a lens actuation unit 120, an image sensor 130, a computation unit 140, a lens control unit 150, and a mode determination unit 160.

The lens unit 110 is installed inside a camera module, is used to receive images of an external subject, and includes a plurality of lens groups so as to transmit external images to the image sensor 130 inside the camera module. Furthermore, the lens unit 110 performs focusing on the basis of a subject while it is linearly moved in the direction of an optical axis by the lens actuation unit 120 in order to increase the resolution of images displayed on a display unit 170.

The lens actuation unit 120 is used to move the lens unit 110 in the direction of an optical axis, and may be formed of a typical piezoelectric element or Voice Coil Motor (VCM). Here, the lens actuation unit 120 performs the auto focusing of the lens unit 110 by moving the lens unit 110 a short distance or a long distance. Here, it is preferred that the lens actuation unit 120 have the speed that enables real-time continuous auto focus on the basis of a preset threshold value.

The image sensor 130 receives external images through the lens unit 110, converts the external images into image signals, and outputs the image signals. The image signals are transmitted to and processed by the computation unit 140. Here, a CCD or CMOS maybe used as the image sensor 130.

The computation unit 140 performs signal processing, such as Auto Exposure (AE) and Auto White Balance (AWB), on the image signals output from the image sensor 130, and stores the results of the processing in a memory unit 180. Furthermore, the computation unit 140 includes a loop for searching for a specific subject of interest using the specific parameter or feature data of the subject stored in the memory unit 180. Furthermore, the computation unit 140 can determine whether a variation, which is the difference between a focus value for a second image pickup region at an optimal lens location for a first image pickup region and an optimal focus value for the first image pickup region, falls within a threshold value range stored in the memory unit 180. The loop for searching for such a specific subject of interest and the auto focusing scheme will be described in detail below.

The lens control unit 150 is used to transmit a control signal to the lens actuation unit 120 in order to perform auto focusing on a subject to move the lens unit 110 a short distance or a long distance. The lens control unit 150 determines whether the lens unit 110 has been focused on a subject using a Focus Value (FV), which is auto focus data created by the computation unit 140 and stored in the memory unit 180, and transmits a control signal to the lens actuation unit 120.

The mode determination unit 160 sets mode according to the characteristics of a subject by performing automatic switching between general mode, specific mode and tracking mode, and performs continuous auto focusing on a subject using a fixed or variable window on the basis of the set mode. Here, in general mode, a fixed window is set, whereas in specific mode and tracking mode, a variable window that follows a subject is set.

Here, subjects may be classified into specific objects and general environmental objects.

Specific objects are classified into human faces, animals or moving objects, and objects selected by a user, and are continuously auto-focused using a variable window. General environmental objects are classified into faces, animals and nature backgrounds, and are continuously auto-focused using a fixed window.

Such classification as specific objects and general environmental objects are performed according to the mode selected by the mode determination unit 160. That is, a human face, an animal and a moving object become general environmental objects auto-focused using a fixed window in the general mode, whereas they become specific objects auto-focused using a variable window in the specific mode or tracking mode.

The general mode is applied to a general still camera. In the general mode, auto focusing is performed on a subject using a fixed window. Here, since the general mode has lower priority than the specific mode, the specific mode is performed unless the general mode is selected by a user.

The specific mode is chiefly used to capture moving images. In the specific mode, auto focusing is performed on a subject using a variable window. Here, since the specific mode has higher priority than the general mode, the specific mode is performed unless the general mode or the tracking mode is selected by a user. Furthermore, in the specific mode, the feature parameters of a specific object are calculated and stored in the memory unit 180. A method using the edges or colors of a subject may be used as a method of calculating feature parameters.

The tracking mode is performed when one general environment object is selected from among general environmental objects displayed on the display unit 170 by a user. In the case where a feature parameter corresponding to a subject selected by a user is stored in the memory unit 180, a variable window is set for the selected subject. In the case where a feature parameter is not stored in the memory unit 180, a fixed window is set for the subject.

FIG. 2 is a flowchart showing a method of automatically controlling continuous auto focus using the device for automatically control continuous auto focus, which is shown in FIG. 1.

The method of automatically controlling continuous auto focus according to the present invention includes auto focus initialization step S110, step S120 of selecting general mode, specific mode or tracking mode so as to set a fixed or variable window for a subject, first scan step S130 for a first image pickup region, second scan step S140, step S150 of moving a lens to an optimal lens location, step S170 of determining whether a variation falls within a threshold range after an image pickup region has been switched to a second image pickup region, third scan step S160 of moving a lens on the basis of the variation, and step S190 of determining whether the mode has been switched from the specific mode to the general mode.

At the auto focus initialization step S110, the entire interval through which the lens unit 110 can be moved is scanned in order to determine the interval from which focus values are detected. In this case, the interval from which the focus values are detected is designated, and the steps of the first scan interval and the second scan interval are determined and designated. Thereafter, the lens control unit 150 moves the lens unit 110 to an initial location or a reference location.

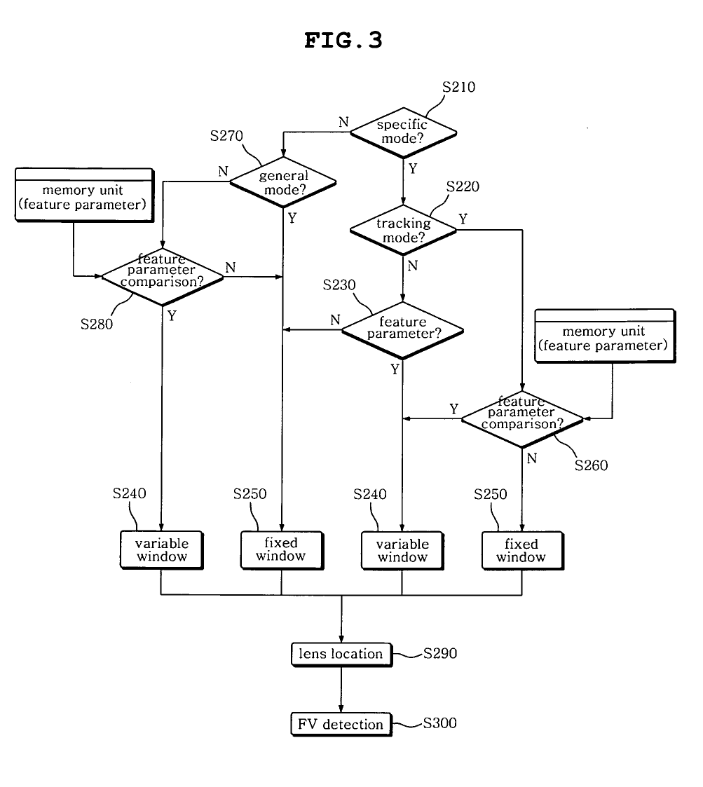

The mode selection step S120 is a step of automatically switching among the general mode, the specific mode and the tracking mode according to the characteristics of a subject, automatically setting the general mode, the specific mode or the tracking mode according to the characteristics of a subject, and setting a fixed window or a variable window according to the set mode. The mode selection step S120 will be described in detail below with reference to the flowchart of FIG. 3.

As shown in FIG. 3, at the mode selection step S120, the general mode, the specific mode or the tracking mode is determined, and a fixed window or a variable window is set for the determined mode.

First, it is determined whether the specific mode has been set at step S210. That is, the specific mode has higher priority than the general mode, and is performed unless the general mode or tracking mode is forcibly selected by the user.

Thereafter, it is determined whether the tracking mode has been set by the user while the specific mode is performed at step S220. If the specific mode is being performed, the feature parameter of the subject is detected for each frame of a captured moving image at step S230.

If the feature parameter is detected from the frame, the subject from which the feature parameter is detected is determined to be a specific object, a variable window is set for the specific object at step S240, and the detected feature parameter is stored in the memory unit 180. Here, if the feature parameter is not detected from the frame, it is determined that the specific object does not exist in the frame, with the result that a fixed window is set and switching to the general mode is automatically performed at step S250.

Meanwhile, if the tracking mode is set by the user, that is, if one subject is selected from among various subjects displayed on the display unit 170 by the user, while the specific mode is performed, the feature parameter of the selected subject is compared with the feature parameters of specific objects stored in the memory unit 180 at step S260. If parameters are similar to each other, a variable window is set for the selected subject by the user at step S240. In contrast, if the parameters are not similar to each other, a fixed window is set and switching to the general mode is automatically performed at step S250.

If the general mode is forcibly set by the user at step S270, a fixed window is set and continuous auto focusing is performed on the basis of the fixed window at step S250. Meanwhile, if the tracking mode is set by the user, that is, if one subject is selected from among various subjects displayed on the display unit 170, while the general mode is performed, the feature parameter of the selected subject is compared with the feature parameters of the specific objects stored in the memory unit 180 at step S280. If the parameters are similar to each other, a variable window is set for the selected subject by the user at step S240. In contrast, if the parameters are not similar to each other, a fixed window is set and switching to the general mode is automatically performed at step S250.

Through the above-described process, the fixed or variable window for continuous auto focusing is set. Lens locations and focus values at these locations are detected from the selected window so as to perform the location control of the lens unit and are stored in the memory unit 180 at steps S290 and S300. Here, the detected focus value is used for the first scan at the first scan step S130.

The first scan step S130 is configured to scan focus values at preset first intervals for the first image pickup region by moving the lens unit 110 along an optical axis.

The lens unit 110 has the fixed entire range of movement, and may be moved along the axis of movement. The lens actuation unit 120 for moving the lens unit 110 is provided, and may operate in response to actuation signals generated by an auto focusing algorithm.

At the first scan step S130, it is possible to equally divide the entire range of movement of the lens unit 110 by the first interval and to measure focus values for images at the locations of the equal division for the first image pickup region while moving the lens unit 110 from macro to infinity.

At the second scan step S140, it is possible to scan focus values at preset second intervals in the second scan region including a lens location at an optimal one of the focus values scanned at the first scan step S130. The optimal focus value may be the greatest of the scanned focus values.

The second scan region may exist between lens locations having focus values within the preset focus range at the optimal one of the focus values scanned at the first scan step S130. The focus value range for determining the second scan region may be determined to be an appropriate value range through experiments. Here, focus values at the locations of the lens unit 110 corresponding to the upper and lower limits of the second scan region may be the same.

In the present embodiment, it is possible to equally divide the second scan region by the second interval and measure focus values for images at the locations of the equal division while moving the lens within the second scan region. Here, the second interval may be configured to be narrower than the first interval at the first scan step S130.

At the step S150 of moving the lens unit 110 to an optimal lens location, the lens unit 110 may be placed at an optimal lens location having an optimal focus value at the second scan step.

The optimal focus value at the second scan step S140 may be the greatest of the scanned focus values. If the lens unit 110 is placed at the optimal lens location, the optimal focusing for the first image pickup region is completed.

At the step S170 of determining whether the variation falls within the preset threshold range, after the image pickup region has been switched from the first image pickup region to the second image pickup region, it can be determined that the variation, which is the difference between a focus value for the second image pickup region at the optimal lens location at the second scan step and the optimal focus value at the second scan step, falls within the preset threshold range. The threshold value may be determined from experiments. The threshold value may have a range within which the optimal focus value for the second image pickup region can be located within the second scan range, even though the second scan range for the first image pickup region is not changed.

If the image pickup region has been switched from the first image pickup region to the second image pickup region, the focus value for the second image pickup region at the optimal lens location, which is an optimal focusing location for the first image pickup region, differs from the optimal focus value for the first image pickup region.

At the present step, the difference between the focus value for the second image pickup region at the optimal lens location, which exhibits an optimal focus value for the first image pickup region, and the optimal focus value may be defined as the variation. At the present step, it can be determined whether the variation falls within the preset threshold range. That is, the present step is a step of determining whether the absolute value of the value obtained by subtracting the optimal focus value from the focus value for the second image pickup region at the optimal lens location, which is measured at the second scan step, is less than the preset threshold value.

At the third scan step S160, the lens may be moved on the basis of the variation determined at the determination step S170.

If at the determination step S170, the variation falls within the threshold range, the process may proceed from the third scan step S160 to the second scan step S140. At the present step, it is possible to scan focus values for the second image pickup region by moving the lens unit 110 at the second scan intervals determined at the step of scanning the first image pickup region. The lens unit 110 may be moved to the optimal lens location determined at the second scan step.

If at the determination step S170, the variation deviates from the threshold range, the process may proceed from the third scan step S160 to the first scan step S130. That is, it is possible to scan focus values for the second image pickup region while moving the lens from macro to infinity. After the first scan step S130 has been performed, the second scan step S140 may be performed and the lens unit 110 may be moved to the optimal lens location determined at the second scan step S140.

In the present embodiment, it is possible to further include, before the first scan step S130, step S180 of determining a scan direction. That is, for the second image pickup region, it is possible to determine the direction in which the lens will be moved from the current location of the lens unit 110 in order to perform the first scan step S130.

As described above, if the difference between the first image pickup region and the second image pickup region is not great, the time required for the scan can be reduced by proceeding directly to the second scan step S140 rather than to the first scan step S130, and the power required for the movement of the lens unit 110 for the scan can be decreased.

Meanwhile, the process may further include, after the step S180 of determining a scan direction, step S190 of determining whether the mode has been switched from the specific mode to the general mode. That is, if the mode has been switched through the forcible setting of the general mode by the user, the tracking mode may be performed in such a way that the user arbitrarily selects one subject from among various subjects displayed on the display unit 170 by performing the mode selection step S120 again. If the mode has not been switched from the specific mode to the general mode, the process proceeds to the first scan step S130 and then continuous auto focusing is performed on the basis of the currently set fixed or variable window.

In more detail, in the case where auto focusing is performed while the specific mode is maintained, the first scan step S130 is performed on the basis of a variable window set for a specific object. In contrast, in the case where the mode has been switched from the specific mode to the tracking mode -and then auto focusing is performed, the first scan step S130 is performed on the basis of a variable window set for a specific object selected by the user. In contrast, in the case where the mode has been switched from the general mode to the tracking mode and then auto focusing is performed, the first scan step S130 is performed on the basis of a variable window set for a specific object selected by the user.

In accordance with the above-described device and method for automatically controlling continuous auto focus according to the present invention, when a subject is captured using a mobile device, automatic real-time switching between fixed and variable windows can be performed according to the characteristics of the subject, and continuous auto focusing can be achieved on the basis of the fixed or variable window, thereby reducing the time required for auto focusing on an object of interest during the capture of a moving image and providing high resolution.

A process of capturing a moving image and performing continuous auto focusing on a subject using the above-described device and method for automatically controlling continuous auto focus will be described below.

When the user operates the mobile device in order to capture a moving image in the case where a moving image of a human face is captured, the auto focus initialization step S110 and the mode selection step S120 are sequentially performed.

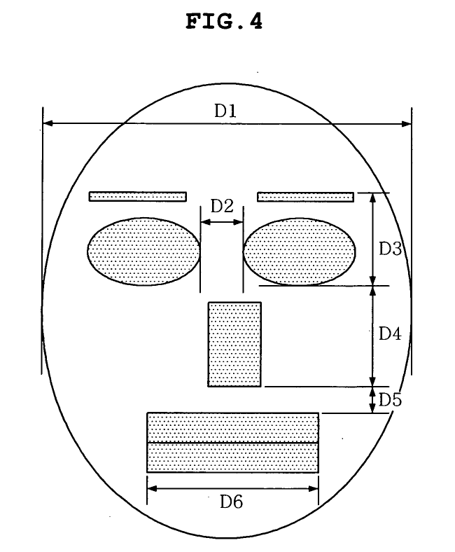

Since at the mode selection step S120, the specific mode having the highest priority is automatically set, the steps S210 and S220 are sequentially performed and a feature parameter is detected from each frame of the moving image. In this case, the human face is a target, with the result that the edge information of the face, that is, the parameters of features such as the eyes, the nose and the mouse, are detected and are stored in the memory unit 180 at step S230, as illustrated in FIG. 4. The face recognized in the specific mode is recognized as the specific object and a variable window is set for the face at step S240.

Thereafter, the steps S130, S140 and S150 for continuous auto focusing are sequentially performed on the basis of a variable window. If the face for which the variable window is set moves, the scan operation of the lens unit 110 for auto focusing is performed to be suitable for the extent of the movement of the face at steps S170 and S160. That is, if the variation is less than the threshold value because the movement of the face is small, the second scan step S140 is performed so that auto focusing is performed on the face. In contrast, if the variation is equal to or greater than the threshold value because the movement of the face is large, the scan direction of the lens unit 110 is determined at step S180, it is determined whether the switching from the specific mode to the general mode has been performed at step S190, and one of the mode selection step S120 and the first scan step S130 is performed.

As described above, when a moving image is captured, a fixed or variable window is automatically set according to the characteristics of a subject and the scan time can be changed by determining the extent of the movement of the subject, thereby performing focusing on the subject in real time.

Although the device and method for automatically controlling continuous auto focus according to the present invention has been described with reference to the preferred embodiments of the present invention, those skilled in the art will appreciate that various modifications, additions and substitutions are possible, without departing from the scope and spirit of the invention as disclosed in the accompanying claims.

1. A device for automatically controlling continuous auto focus, comprising:
a lens unit installed in a camera module, and configured to receive images of an external subject;
a lens actuation unit for moving the lens unit along a direction of an optical axis so as to perform focusing on a subject;
an image sensor for receiving the external images through the lens unit, converting the external images into image signals, and outputting the image signals;
a computation unit for detecting focus values and feature parameters of the subject from the image signals;
a mode determination unit for automatically performing switching between general mode, specific mode and tracking mode for the subject, setting the mode for the subject, and automatically setting a fixed or variable window for the subject according to the set mode using the feature parameters detected by the computation unit; and
a lens control unit for generating a control signal for controlling the lens actuation unit so that continuous auto focus is performed according to the focus values detected by the computation unit.

2. The device as set forth in claim 1, wherein the mode determination unit sets the fixed window in the general mode, and sets the variable window in the specific mode and the tracking mode.

3. The device as set forth in claim 2, wherein the variable window is set for the subject selected by a user in the tracking mode.

4. The device as set forth in claim 3, wherein the variable window is set for the subject for which a feature parameter is detected from each frame of a moving image in the specific mode.

5. The device as set forth in claim 3, wherein the tracking mode is configured to set the variable window for the subject selected by the user.

6. The device as set forth in claim 3, wherein the computation unit performs continuous auto focusing on a basis of the fixed or variable window set by the mode determination unit, the computation unit determining whether a variation, which is a difference between a focus value for a second image pickup region at an optimal lens location for a first image pickup region and an optimal focus value for the first image pickup region, falls within a threshold value range stored in a memory unit.

7. A method of automatically controlling continuous auto focus, comprising:
selecting general mode, specific mode and tracking mode so that a fixed or variable window is automatically set according to characteristics of a subject;
scanning focus values at first intervals for a first image pickup region by moving a lens unit on a basis of the fixed or variable window;
setting a second scan region including a location of the lens unit at an optimal focus value selected from among the focus values scanned at the scanning focus values at first intervals, and scanning focus values at second intervals on a basis of the fixed or variable window in the second scan region;
placing the lens unit at an optimal lens location having an optimal focus value at the setting a second scan region;
after an image pickup region has been switched from the first image pickup region to a second image pickup region, determining whether a variation, that is, a difference between a focus value for the second image pickup region and the optimal focus value at the second scan step, falls within a threshold range at the optimal lens location; and
moving the lens unit on a basis of the variation determined at the determining whether a variation falls within a threshold range.

8. The method as set forth in claim 7, wherein the selecting comprises setting the fixed window in the general mode and the variable window in the specific mode and the tracking mode.

9. The method as set forth in claim 8, wherein the specific mode has highest priority, so that the specific mode is first performed unless the general mode or the tracking mode is set by the user.

10. The method as set forth in claim 9, wherein the tracking mode is set when one subject is selected from among a plurality of subjects within the image pickup region by the user.

11. The method as set forth in claim 9, wherein the selecting comprises determining whether the specific mode has been set, determining whether the tracking mode has been set by the user while the specific mode is performed, detecting a feature parameter of the subject for each frame of a captured moving image if the specific mode is being performed, recognizing the subject from which the feature parameter is detected as a specific object if the feature parameter has been selected from the frame, and setting the variable window for the specific object.

12. The method as set forth in claim 11, wherein, if the feature parameter has not been detected from the frame of the moving image, a mode is automatically switched from the specific mode to the general mode and the fixed window is set.

13. The method as set forth in claim 11, wherein, if the tracking mode is set by selection of one subject from among the plurality of subjects by the user in the specific mode, a feature parameter detected from the selected subject is compared with feature parameters stored in a memory unit.

14. The method as set forth in claim 13, wherein, if a parameter similar to the feature parameter detected from the selected subject exists in the memory unit, the variable window is set for the selected subject.

15. The method as set forth in claim 13, wherein, if a parameter similar to the feature parameter detected from the selected subject does not exist in the memory unit, a mode is automatically switched from the tracking mode to the general mode and the fixed window is set.

16. The method as set forth in claim 9, wherein the selecting comprises, if the general mode has been set by the user, determining whether the tracking mode has been set by the user in the general mode, and setting the fixed window if the general mode is being performed.

17. The method as set forth in claim 16, wherein, if the tracking mode is set by selection of one subject from among the plurality of subjects by the user in the general mode, a feature parameter detected from the selected subject is compared with feature parameters stored in a memory unit.

18. The method as set forth in claim 17, wherein, if a parameter similar to the feature parameter detected from the selected subject exists in the memory unit, the variable window is set for the selected subject.

19. The method as set forth in claim 17, wherein, if a parameter similar to the feature parameter detected from the selected subject does not exist in the memory unit, a mode is automatically switched from the tracking mode to the general mode and the fixed window is set.

20. The method as set forth in claim 9, wherein the second scan region exists between lens locations having focus values within a preset focus range at an optimal one of the focus values scanned at the scanning focus values at first intervals.

21. The method as set forth in claim 9, wherein each of the second intervals are narrower than each of the first intervals.

22. The method as set forth in claim 9, wherein moving the lens unit comprises, if the variation falls within the threshold range, performing the setting a second scan region on the second image pickup region.

23. The method as set forth in claim 9, wherein moving the lens unit comprises, if the variation deviates from the threshold range, setting a direction in which the lens unit is moved and then determining whether a mode has been switched from the specific mode to the general mode.

24. The method as set forth in claim 23, wherein, if a mode has been switched from the specific mode to general mode, the selecting is performed.

25. The method as set forth in claim 23, wherein, if a mode has not been switched from the specific mode to general mode, the scanning focus values at first intervals is performed on the second image pickup region.
